(19) United States
(12) Patent Application Publication
(10) Pub. No.: US 2025/0200250 A1
(43) Pub. Date: Jun. 19, 2025

(54) BICYCLE DESIGN METHOD, BICYCLE DESIGN SYSTEM, AND COMPUTER PROGRAM STORED ON RECORDING MEDIUM FOR EXECUTING THE BICYCLE DESIGN METHOD

(71) Applicant: LM Solution Inc., Gyeonggi-do (KR)

(72) Inventor: Chang Hyeon IM, Seoul (KR)

(73) Assignee: LM Solution Inc., Gyeonggi-do (KR)

(21) Appl. No.: 18/926,317

(22) Filed: Oct. 25, 2024

(30) Foreign Application Priority Data
Dec. 13, 2023 (KR) 10-2023-0181153

(51) Int. Cl. G06F 30/27; G06F 30/12; G06F 30/15; G06F 111/16

(52) U.S. Cl. CPC G06F 30/27; G06F 30/12; G06F 30/15; G06F 2111/16

(57) ABSTRACT

A bicycle design method includes obtaining user data input from a user device through one or more processors, extracting user text data from the user data through the one or more processors, generating processed command data by performing natural language processing (NLP) on the user text data through the one or more processors, and generating a bicycle design by using the command data, wherein the generating of the bicycle design includes determining a bicycle design element by applying a first machine learning model to the command data and determining one or more bicycle designs by applying a second machine learning model to the determined bicycle design element.

### CROSS-REFERENCE TO RELATED APPLICATION

This application is based on and claims priority under 35 U.S.C. § 119 to Korean Patent Application No. 10-2023-0181153, filed on Dec. 13, 2023, in the Korean Intellectual Property Office, the disclosure of which is incorporated by reference herein in its entirety.

### BACKGROUND

### 1. Field

The disclosure relates to a bicycle design method and system, automated using machine learning, and a computer program stored on a recording medium to execute the bicycle design method.

### 2. Description of the Related Art

In designing a bicycle to suit a user, bicycle fitting is done based on the experience of a few experts to prevent repetitive fatigue in each part of a body when using the bicycle by adjusting the structure of the bicycle to suit the user's characteristics, use environment, purpose and method of use, user's habits, etc. For athletes or top-of-the-line bicycle models, the bicycle is custom-made from the start to fit the user's body type.

No matter what type of bicycle the user rides, whether the bicycle is a hybrid bicycle (a hybrid bicycle for both on and off-road use), a folding bicycle, a road bicycle, a track bicycle, a cyclo-cross bicycle, a mountain bicycle (MTB), a trial bicycle, or a BMX bicycle, the top priority during cycling is that the user feels comfortable and efficient without much strain on the body of the user by selecting a bicycle that is the right size for the physical condition of the user and to adjust the position of the saddle and handlebars to suit the user's physical condition and cycling posture according to the purpose of cycling.

As such, when the bicycle is not properly fitted to the user, various problems may occur in each part of the user's body and there is a risk of serious injury to very important joints or ligaments such as the wrists, shoulders, waist, hips, and knees. Thus, bicycle fitting may be one of the important factors along with bicycle selection.

In particular, the bicycle has a different geometry depending on the type, brand, design, etc., and even for people with the same height, the structure of the bicycle to be comfortable to the body is different depending on various body sizes such as the leg length, arm length, and shoulder width as well as the bicycle use environment and riding habits, and the gender and age of the user.

As a result, fitting is done by a small number of experts, and as local bicycle fitting is performed based on the long experience and know-how of the experts, it is not easy for the general public to access bicycle fitting. Moreover, fitting criteria may be applied differently depending on experts.

In addition, even with manual fitting, which requires direct data collection for bicycle fitting for each individual user, it takes a lot of time and money because the user has to ask an expert to make additional adjustments to the bicycle size and position based on the user's actual riding habits, personal preferences, etc.

### SUMMARY

Provided are a bicycle design method and system and a computer program stored on a recording medium to execute the bicycle design method so that a bicycle design for maintaining the most comfortable posture considering the physical characteristics and riding style of a user may be automatically provided to the user by using machine learning. However, such a problem is just an example, and the scope of the disclosure is not limited thereto.

Additional aspects will be set forth in part in the description which follows and, in part, will be apparent from the description, or may be learned by practice of the presented embodiments of the present disclosure.

According to an aspect of the disclosure, a bicycle design method includes obtaining user data input from a user device through one or more processors, extracting user text data from the user data through the one or more processors, generating processed command data by performing natural language processing (NLP) on the user text data through the one or more processors, and generating a bicycle design by using the command data, in which the generating of the bicycle design includes determining a bicycle design element by applying a first machine learning model to the command data and determining one or more bicycle designs by applying a second machine learning model to the determined bicycle design element.

The user data may include user input data obtained by the user directly inputting data such as a gender, an age, a desired bicycle type, a desired bicycle design, etc., body analysis data obtained by using a body measurement device, such as user's height, weight, body size, etc., and riding test data obtained by the user performing a riding test using a riding test device.

The generating of the bicycle design may include recommending a bicycle design by using additional data (e.g., adjustment using a riding test, etc.) not included in the user data through application of a design recommendation engine.

The determining of the plurality of bicycle designs by applying the second machine learning model to the determined bicycle design element may include an operation of determining one or more bicycle designs among a plurality of preset standard bicycle designs by applying a 2nd-1 machine learning model to the determined bicycle design element.

The first machine learning model may include a plurality of GAN configured to identify the one or more bicycle design elements.

The second machine learning model may include a CNN configured to determine the bicycle design based on the one or more bicycle design elements.

The generating of the processed command data by performing NLP on the user text data through the one or more processors may include performing vectorization on text data including the user text data in which each of the plurality of vectors may include one or more embedding.

The bicycle design method may further include performing NER on the plurality of vectors to identify the one or more bicycle design elements or a combination thereof.

The bicycle design method may further include determining a final bicycle design by applying a third machine learning model to the one or more bicycle designs.

According to another aspect of the disclosure, a bicycle designing system includes a memory storing one or more computer-readable instructions and a processor configured to execute the one or more instructions stored in the memory, in which the processor is further configured to obtain user data input from a user device, extract user text data from the user data, generate processed command data by performing natural language processing (NLP) on the user text data, and generate a bicycle design by using the command data, in which the bicycle design is such that a bicycle design element is determined by applying a first machine learning model to the command data, one or more bicycle designs are determined by applying a second machine learning model to the determined bicycle design element, and a final bicycle design is determined by applying a third machine learning model to the one or more bicycle designs.

According to another aspect of the disclosure, a computer program is provided which is stored on a recording medium for executing the above-described bicycle design method by using a computer.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram showing a network environment of a bicycle design system according to embodiments;

FIG. 2 is a block diagram showing an example of a memory according to an embodiment of the disclosure;

FIG. 3 is a block diagram showing an example of a sensing unit according to an embodiment of the disclosure;

FIG. 4 is a block diagram showing an example of a memory of a server according to an embodiment of the disclosure;

FIG. 5 is a block diagram showing an example of an automated bicycle design system according to an embodiment of the disclosure;

FIG. 6 is a block diagram showing an example of a bicycle design system capable of selecting a bicycle design optimized for a bicycle user and providing the same to the bicycle user by using machine learning, according to an embodiment of the disclosure;

FIG. 7 illustrates bicycle design elements according to embodiments of the disclosure;

FIG. 8 is a flowchart showing a bicycle design method according to embodiments; and

FIG. 9 is a flowchart showing an operation of generating a bicycle design according to embodiments.

### DETAILED DESCRIPTION

Reference will now be made in detail to embodiments, examples of which are illustrated in the accompanying drawings, wherein like reference numerals refer to like elements throughout. In this regard, the current embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

The disclosure may have various modifications thereto and various embodiments, and thus particular embodiments will be illustrated in the drawings and described in detail in a detailed description. Effects and features of the disclosure, and methods for achieving them will become clear with reference to the embodiments described later in detail together with the drawings. However, the disclosure is not limited to the embodiments disclosed below and may be implemented in various forms.

Hereinafter, embodiments will be described in detail with reference to the accompanying drawings, and in description with reference to the drawings, the same or corresponding components are given the same reference numerals, and redundant description thereto will be omitted.

In the following embodiments, the terms such as first, second, etc., have been used to distinguish one component from other components, rather than limiting. Singular forms include plural forms unless apparently indicated otherwise contextually. Herein, the terms “include”, “have”, or the like, are intended to mean that there are features, or components, described herein, but do not preclude the possibility of adding one or more other features or components.

In the drawings, the size of components may be exaggerated or reduced for convenience of description. For example, since the size and thickness of each component shown in the drawings are arbitrarily shown for convenience of description, the disclosure is not necessarily limited to the illustrated bar.

In the following embodiments, when a portion, such as a region, a component, a portion or unit, a block, a module, etc., is present on or above another portion, this case may include not only a case where it is directly on the other portion, but also a case where another region, component, portion or unit, block, module, etc., is arranged between the portion and the other portion. When a region, a component, a portion or unit, a block, a module, etc., are connected, this case may include not only a case where a region, a component, a portion or unit, a block, and a module are directly connected, but also a case where they are connected indirectly by another region, component, portion or unit, block, and module arranged therebetween.

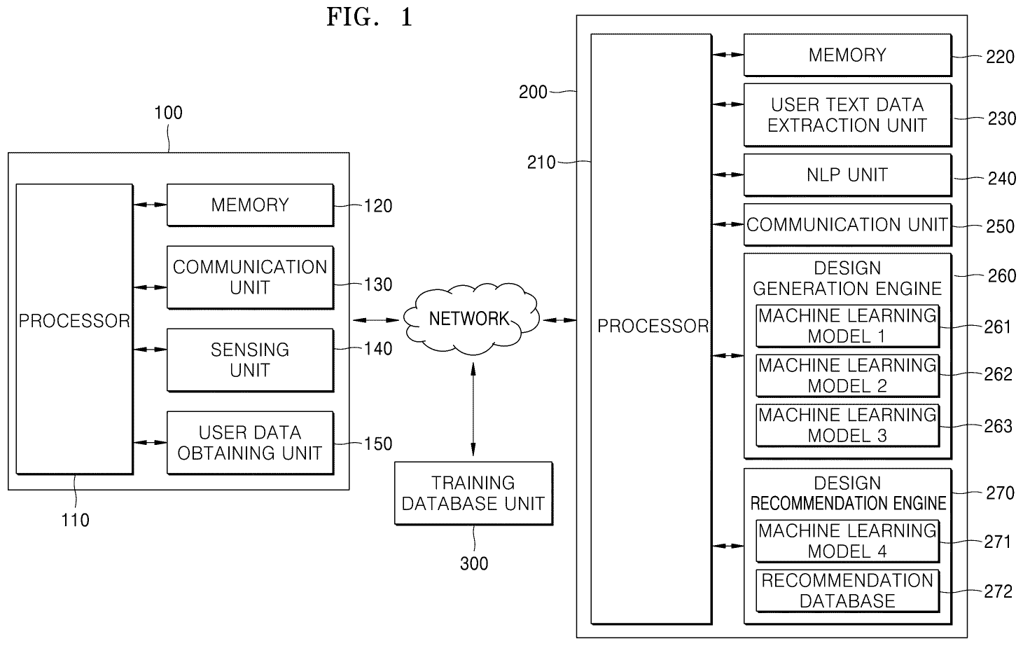

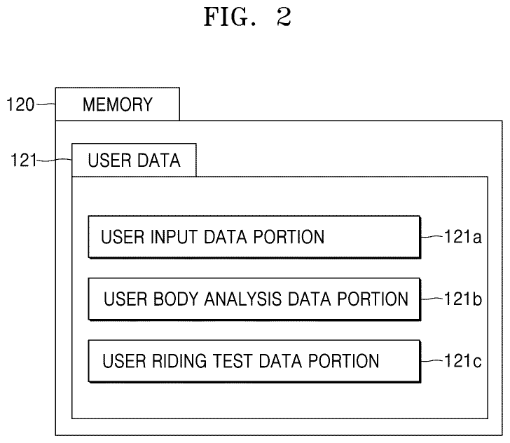

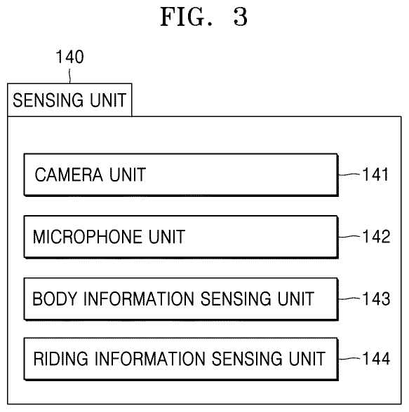

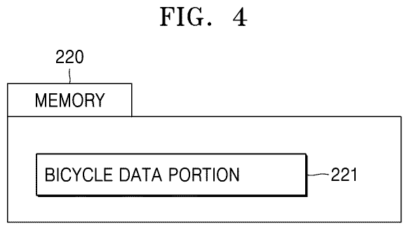

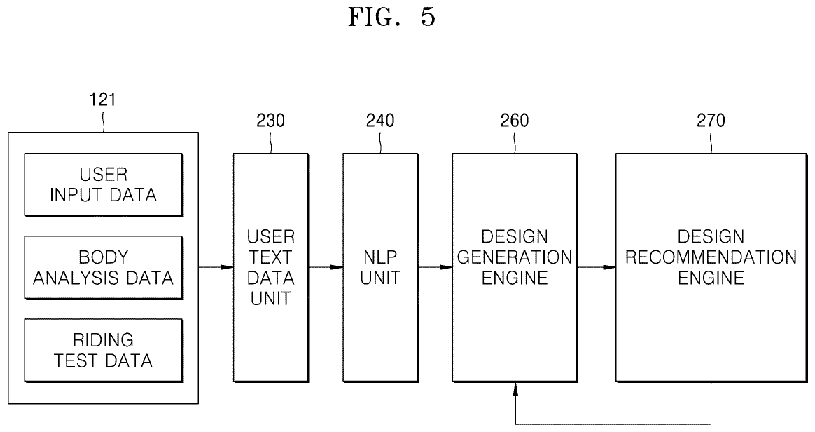

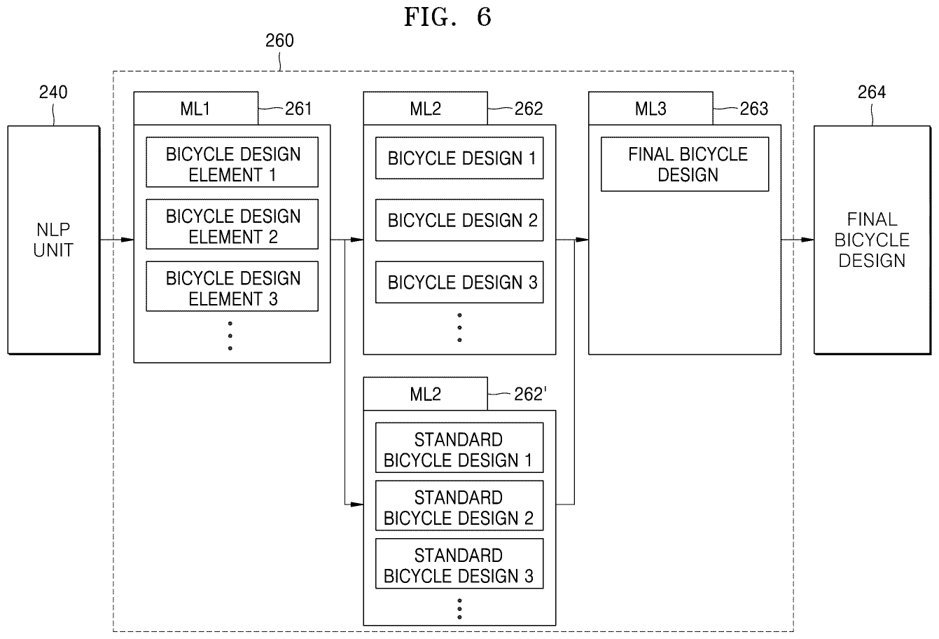

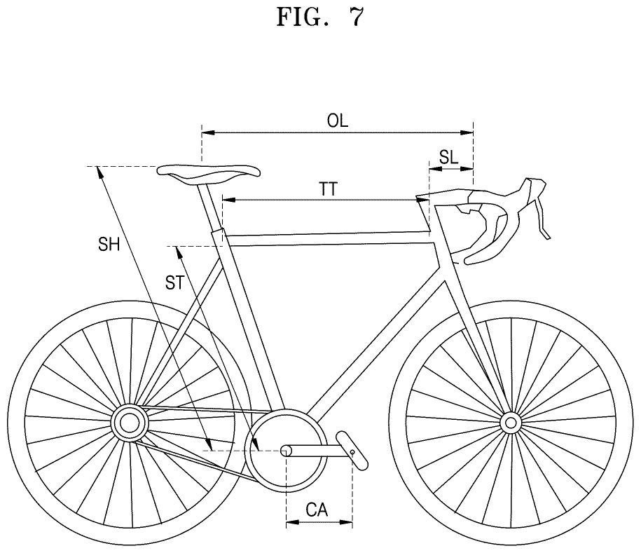

FIG. 1 is a block diagram showing a network environment of a bicycle design system according to embodiments. FIG. 2 is a block diagram showing an example of a memory according to an embodiment of the disclosure. FIG. 3 is a block diagram showing an example of a sensing unit according to an embodiment of the disclosure. FIG. 4 is a block diagram showing an example of a memory of a server according to an embodiment of the disclosure. FIG. 5 is a block diagram showing an example of an automated bicycle design system according to an embodiment of the disclosure. FIG. 6 is a block diagram showing an example of a bicycle design system capable of selecting a bicycle design optimized for a bicycle user and providing the same to the bicycle user by using machine learning, according to an embodiment of the disclosure. FIG. 7 illustrates bicycle design elements according to an embodiment of the disclosure.

As shown in FIG. 1, a bicycle design system may include a user device 100, a server 200, and a training database unit 300.

The user device 100 may include a processor 110, a memory 120, a communication unit 130, and a sensing unit 140. However, the disclosure is not limited thereto, and the user device 100 may further include other components or some components may be omitted therefrom. Some components of the user device 100 may be separated into a plurality of devices, or a plurality of components of the user device 100 may be integrated into one device.

The processor 110 may obtain user data input from the user device 100. The user data may include user input data obtained by the user directly inputting data such as a gender, an age, a desired bicycle type, a desired bicycle design, etc., body analysis data obtained by using a body measurement device, such as user's height, weight, body size, etc., and riding test data obtained by the user performing a riding test using a riding test device.

The user input data may be generated in such a manner that when the user directly inputs data by using the user device 100 carried with the user, the corresponding data is stored in a memory. The stored user input data may be transmitted to a server through a network.

The user device 100 may refer to a communication terminal capable of using a web service in a communication environment. Herein, the user device 100 may be a user's personal computer or a user's portable terminal. The user may input answers to questions asked from the user device 100 by using the user device 100 for a bicycle design suitable for the user. In this case, the user device 100 may have installed therein an interface enabling the user to input information. The user may input information required for the bicycle design to the user device 100 through the interface.

In this case, the user device 100 may be a device having a recording function. At this time, the user may verbally input information required for the bicycle design to the user device 100. The information input by the user may include a gender, an age, a desired bicycle type, a desired bicycle design, etc., of the user. In addition, the input information may further include desired handlebar type, riding purpose (e.g., delivery, mountain biking, or road bicycle), road surface conditions and gradients of frequently used roads, desired wheel size, etc. The user may directly input user-input data into the user device 100. The input information may be stored in a user input data portion 121a of user data 121.

The user body analysis data may be generated in such a manner that body analysis information, such as a height, a weight, a body size for each part, muscle mass for each part, etc., of the user, measured by the body measurement device measuring the user's body, is stored in the memory. The body measurement device may transmit the measured user's body analysis information to the memory of the user terminal through the communication unit 130. The user body analysis data stored in the memory may be transmitted to the server through the network.

The body measurement device may measure information about a fat amount and a muscle mass, such as user's weight, skeletal muscle mass, body fat mass, BMI, body fat percentage, etc., and measure sizes of body parts, such as user's inseam length, arm length, trunk length, forearm length, outseam length, fore arm length, etc., which may be important factors for determining sizes of main components of the bicycle in bicycle riding. The measured body analysis data may be stored in a user body analysis data portion 121b of the user data 121.

The user riding test data may be generated in such a manner that when the user performs a riding test by using a riding test device, the riding test information obtained through the riding test device is stored in the memory. The measured user riding test data may be transmitted to the memory of the user terminal through the communication unit 130. The user riding test data stored in the memory may be transmitted to the server through the network.

The riding test device may measure user's riding habits. Specifically, the riding test device may include measurement equipment such as an infrared camera sensor or a 3D body scanner for accurate measurement of body characteristics of the user. The riding test device may include a virtual driver tester, etc., through which the user may experience riding by using a head-mounted device (HMD), etc., in a virtual riding space. The measured user riding test data may be stored in a user's riding test data portion 121c of the user data 121 of the memory 120.

The processor 110 may measure the user data using the sensing unit 140. For example, the processor 110 may measure a size for each body part by using the camera of the sensing unit 140 to obtain data the corresponding contents. The processor 110 may record contents about a bicycle design desired by the user using a microphone of the sensing unit 140 to obtain the corresponding contents as data. The processor 110 may sense body information by using the body measuring device of the sensing unit 140. The processor 110 may sense user's riding information by using the riding test device of the sensing unit 140. The processor 110 may include, but not limited to, a processing device such as a microprocessor, a central processing unit (CPU), a processor core, a multiprocessor, an application-specific integrated circuit (ASIC), a field programmable gate array (FPGA), etc.

The memory 120 may be a computer-readable recording medium and include a permanent mass storage device such as random access memory (RAM), read only memory (ROM), and a disk drive. A program code for controlling the user device 100 may be temporarily or permanently stored in the memory 120. For example, the memory 120 may store the user input data, the user body analysis data, the user riding test data, an algorithm for obtaining and storing the data, etc.

The communication unit 130 may provide a function for communicating with an external server, a terminal, a database, etc., through the network. For example, a request generated by the processor 110 of the user device 100 according to a program code stored on a recording device such as the memory 120 may be transmitted to the server 200 through the network under control of the communication unit 130. Inversely, a control signal, an instruction, contents, a file, etc., provided under control of the processor 210 of the server 200 may be received by the user device 100 through the communication unit 130 via the network. For example, the control signal, the instruction, etc., of the external server received through the communication unit 130 may be transmitted to the processor 110 or the memory 120.

A communication scheme is not limited and may include short-range wireless communication between devices as well as communications using a communication network (e.g., a mobile communication network, wired Internet, wireless Internet, a broadcast network). For example, the network may include one or more networks among a personal area network (PAN), a local area network (LAN), a campus area network (CAN), a metropolitan area network (MAN), a wide area network (WAN), a broadband network (BBN), Internet, etc. Moreover, the network may include, but not limited to, one or more of network topology including a bus network, a start network, a ring network, a mesh network, a star-bus network, a tree or hierarchical network, etc.

The communication unit 130 may communicate with the external server through a network. The communication scheme is not limited, but the network may be a short-range wireless communication network. For example, the network may be a Bluetooth, Bluetooth low energy (BLE), or wireless fidelity (Wi-Fi) communication network. The communication unit 130 may transmit the user data obtained through the user device 100 to the server 200.

The sensing unit 140 may sense a variety of user data. For example, the sensing unit 140 may measure a size for each body part by using a camera unit 141 to obtain data the corresponding contents. The sensing unit 140 may record contents about a bicycle design desired by the user using a microphone unit 142 to obtain the corresponding contents as data. The sensing unit 140 may sense size information for each body part by using a body information sensing unit 143. The body information sensing unit 143 may include a body measurement device. The sensing unit 140 may sense user's riding information by using a riding information sensing unit 144. The riding information sensing unit 144 may include a riding test device.

A user data obtaining unit 150 may obtain user data input from the user device 100. The user data may include user input data obtained by the user directly inputting data such as a gender, an age, a desired bicycle type, a desired bicycle design, etc., body analysis data obtained by using a body measurement device, such as user's height, weight, body size, etc., and riding test data obtained by the user performing a riding test using a riding test device. The processor 110 may store user data obtained by the user data obtaining unit 150 in the memory 120.

Referring to FIG. 1, the server 200 may include the processor 210, the memory 220, a user text data extraction unit 230, a natural language processing (NLP) unit 240, a communication unit 250, a design generation engine 260, and a design recommendation engine 270.

The processor 210 may extract user text data from the user data and generate processed command data by performing NLP on the user text data. The processor 210 may generate a bicycle design using the command data. In this case, the processor 210 may generate the bicycle design by using various machine learning models of the design generation engine 260.

The processor 210 may implement an artificial neural network model structure. That is, the artificial neural network model may be implemented as hardware or software through the processor 210. The artificial neural network may be trained using big data including user input data, user body analysis data, and user riding test data. Such training may be performed in, for example, the NLP unit 240 to which an artificial intelligence model is applied, the design generation engine 260, or a separate training server. Examples of a training algorithm may include, but not limited to, for example, supervised learning, unsupervised learning, semi-supervised learning, or reinforcement learning.

The artificial neural network model may include a plurality of artificial neural network layers. The artificial neural network may be, but not limited to, a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof. The AI model may additionally or alternatively include a software structure as well as the hardware structure.

The user text data extraction unit 230 may convert information input verbally or as an image showing text by the user into text among contents of the obtained user data. The NLP unit 240 may perform NLP on user text data using a first NLP model to generate processed command data.

When generating the processed command data by performing NLP, vectorization may be performed on the text data to generate a plurality of vectors related to phrases in the user text data. Each of the plurality of vectors may include one or more embedding.

The NLP unit 240 may be configured to interpret a user instruction indicated by the text data by performing NLP on the user text data. The text data may be the user data 121 received from the user device 100. The user data 121 may include text information converted from voice input verbally by the user into text in the user input data portion 121a.

The NLP unit 240 may be configured to perform one or more NLP operations on the text data to analyze, format, process, and detect internal elements of the text data for interpretation of user information indicated by the text data. For example, the NLP unit 240 may train the user data to generate the user input data, the user body analysis data, and the user riding test data as command data information associated with the following bicycle design element by using the first NLP model.

The first NLP model may indicate a publicly large language model (LLM) that may infer a relationship between words in the text data of the big data. The NLP model may analyze and extract meaningful information from the text and thus currently operate in various forms such as machine translation, business classification, chatbot, etc. The first NLP model according to the disclosure may be trained to receive information about the user input data, the user body analysis data, and the user riding test data and generate contents included in the information as command information data associated to the bicycle design element.

For example, to identify one or more bicycle design elements or a combination thereof, named entity recognition (NER) for the plurality of vectors may be performed. The NER may include entity recognition named for relation with specific word or phrases associated to the bicycle design element.

The communication unit 250 may communicate with the external server through a network. The communication scheme is not limited, but the network may be a short-range wireless communication network. For example, the network may be a Bluetooth, Bluetooth low energy (BLE), or wireless fidelity (Wi-Fi) communication network. The communication unit 250 may receive the user data obtained by the user device 100 from the user device 100.

The design generation engine 260 may generate a bicycle design using the command data. Specifically, the design generation engine 260 may generate the bicycle design by using the processed command data generated by performing NLP on the user text data extracted from the user data input from the user device 100.

The bicycle design may be formed by a combination of a plurality of bicycle design elements. The bicycle design elements, which are geometric bicycle elements, may generate various bicycle designs by a combination of the bicycle design elements.

Referring to FIG. 7, an example of the bicycle design element may include a seat-tube length ST, a top-tube length TT, a crank arm length CA, a saddle height SH, a stem length SL, an overall reach length OL, etc.

For example, the seat-tube length ST may mean a length from a center of a bottom bracket to a bottom of a top tube and may be calculated by an equation provided below. The top-tube length TT includes a gradient, making calculation complex and measurement difficult, and thus may be calculated using an effective top-tube length. The effective top-tube length may refer to a length from a center of the handlebar to a center of the seat-tube and may be calculated generally by an equation provided below (but the equation may differ with fitting experts or scholars).

$$ST = Inseam Length \times 0.65 ( general criterion , 0.66 or 0.67 may be applied )$$

$$TT = ( Trunk length \times 0.7525 + Forearm Length \times 0.078 + Arm Length \times 0.07 ) - 1$$

A crank arm length CA serving for transmission of a force to a bicycle may refer to a length from a center of a chain ring to a center of a pedal and may be calculated by an equation provided below. As an inside of a kneecap or a ligament may have a strain thereon for a high saddle height SH and a knee may have a strain thereon for a low saddle height SH, a proper saddle height SH may be obtained. The stem is a part connecting a frame to a handlebar of the bicycle, and the stem length SL may affect handling and may be obtained by an equation provided below. The overall reach length OL may refer to a distance from the center of the saddle to the end of the stem. A posture places a lot of load on the trunk for a long overall reach length OL, causing pain in shoulders, neck, and wrists as well as a pressure on the perineal region, and a slouching posture may cause back pain for a short overall reach length OL. The overall reach length OL may be calculated by an equation provided below.

$$CA = 170 mm ( if Inseam Length \leq 0.787 m )$$

$$172.5 mm ( if 0.787 m < Inseam Length < 0.838 m )$$

$$175 mm ( if Inseam Length \geq 0.838 m )$$

$$SH = Inseam Length \times 0.88$$

$$SL = Arm Length \times 0.2 - 4$$

$$OL = ( Trunk Length + Arm Length ) / 2$$

Herein, to extract body data for performing bicycle fitting, body dimensions such as the inseam length, the arm length, the trunk length, and the forearm length described above may be required. Such body dimensions may be obtained through body analysis data using the body measurement device.

The design generation engine 260 may include one or more machine learning models ML. The machine learning model ML may be configured to generate a bicycle design output upon input of command data output through NLP. Such machine learning models ML may include recurrent neural networks, convolutional neural networks, deep neural networks, or other types of artificial neural networks. In other implementation examples, the machine learning models ML may include support vector machines (SVMs), decision trees, random forests, regression models, and other types of machine learning models.

According to the disclosure, the design generation engine 260 may determine a bicycle design element by applying a first machine learning model ML1 261 to the command data. That is, the command data generated by NLP may be input to the first machine learning model ML1 that may output one or more bicycle design elements. At this time, the bicycle design elements may be output with color, size, shape, etc., of each element determined by training of the first machine learning model ML1.

According to the disclosure, the first machine learning model ML1 may include a plurality of generative adversarial networks (GAN) configured to identify one or more bicycle design elements. The GAN may include a generator and a discriminator that compete and cooperate with each other, and may train two deep networks of the generator and the discriminator to solve a problem in an unsupervised learning manner.

For example, the first machine learning model ML1 may generate data in which the command data is applied as a specific value to a specific bicycle design element through a generator of the GAN. It may be predicted whether riding is stable when a virtual user applied with input user data through the user input data, the body analysis data, and the riding test data rides the bicycle applied with the bicycle design formed by the bicycle design element associated with the command data through learning of the discriminator.

The first machine learning model ML1 may enable data of the generator and the discriminator to be generated and trained by using training data of the training database unit 300.

According to the disclosure, the design generation engine 260 may determine a plurality of bicycle designs by applying a second machine learning model ML2 262 to a bicycle design element determined through the first machine learning model ML1. That is, bicycle design elements trained through the first machine learning model ML1 may be input to the second machine learning model ML2 that may output a plurality of bicycle designs by combining the trained bicycle design elements. In this case, the plurality of bicycle designs may output in a state where color, size, shape, etc., for each element of the bicycle are determined by training of the second machine learning model ML2. For example, the bicycle design output through the second machine learning model ML2 may be generated directly as a final bicycle design 264 without passing through a third machine learning model ML3.

According to the disclosure, the second machine learning model ML2 may include a convolution neural network (CNN) configured to determine the bicycle design based on one or more bicycle design elements.

The bicycle design elements corresponding to input data of the second machine learning model ML2 may be image elements including color, size, shape, etc. Thus, by using the CNN referred to as a convolutional product neural network, images of several bicycle design elements may be classified. After bicycle design elements for proper arrangement of the bicycle design elements in a size relationship between the bicycle design elements are extracted, the bicycle design elements may be combined to derive a bicycle design corresponding to an optimal image combination.

According to another embodiment, when a plurality of bicycle designs are determined by applying the second machine learning model ML2 to the determined bicycle design elements, a 2nd-1 machine learning model ML2-1 262′ may be applied to the determined bicycle design elements, thereby determining one or more designs among a plurality of preset standard bicycle designs. That is, one or more designs among preset standard bicycle designs closest to a combination of the bicycle design elements output through the first machine learning model ML1 may be determined. In this case, the 2nd-1 machine learning model ML2-1 may learn classification and combination of the bicycle design elements and output one or more preset standard bicycle designs most similar to a corresponding learning result as bicycle designs. For example, the bicycle design output through the 2nd-1 machine learning model ML2-1 may be generated directly as a final bicycle design 264 without passing through the third machine learning model ML3.

According to the disclosure, by applying the third machine learning model ML3 263 to the one or more bicycle designs, the final bicycle design 264 may be generated. The third machine learning model ML3 may compare each of the one or more bicycle designs with user data to select an optimal bicycle design suitable for user's fitting.

According to the disclosure, additional data not in the user data may be used by applying the design recommendation engine 270, thereby recommending the bicycle design. When there is unwritten data in the user input data, the body analysis data, and the riding test data, the design recommendation engine 270 may use additional recommendation data. That is, the bicycle design determined by the design generation engine 260 and the recommended bicycle design stored in the recommendation database unit 272 may be trained through a fourth machine learning model ML4, thereby generating a final bicycle design.

The server 200 may train the machine learning model ML that uses training data and learns a bicycle design. For example, the server 200 may be configured to train the machine learning model ML using the training data stored in the training database unit 300 accessible to the server 200. For example, the training data of the training database unit 300 may be generated in the memory 220 of the server 200 or in an external database or may be stored in the server 200. The training data may include training data for training of a machine learning model ML. The training data may be bicycle design data of various types.

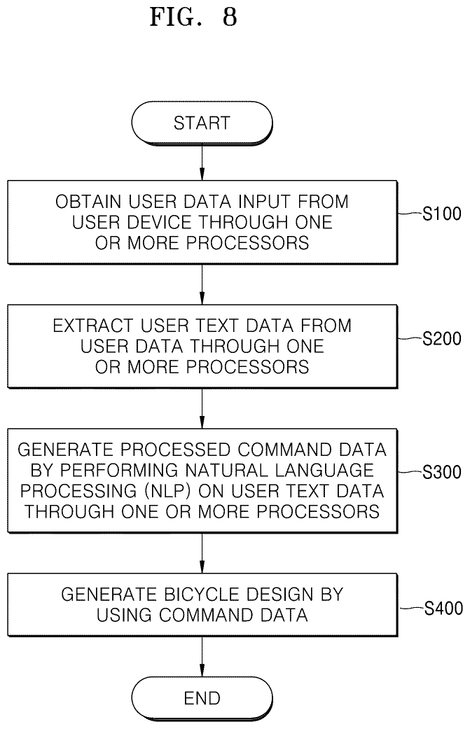

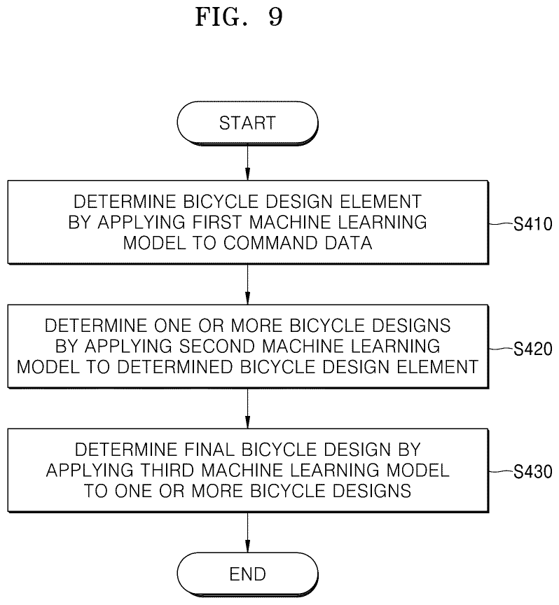

FIG. 8 is a flowchart showing a bicycle design method according to embodiments. FIG. 9 is a flowchart showing an operation of generating a bicycle design according to embodiments.

Referring to FIG. 8, a bicycle design method according to the disclosure may include operation S100 of obtaining user data input from a user device through one or more processors, operation S200 of extracting user text data from the user data by the one or more processors, operation S300 of generating processed command data by performing NLP on the user text data by the one or more processors, and operation S400 of generating a bicycle design by using the command data.

The generating of the bicycle design may include operation S410 of determining a bicycle design element by applying a first machine learning model to the command data, operation S420 of determining one or more bicycle designs by applying a second machine learning model to the determined bicycle design element, and operation S430 of determining a final bicycle design by applying a third machine learning model to the one or more bicycle designs.

Herein, the user data may include user input data obtained by the user directly inputting data such as a gender, an age, a desired bicycle type, a desired bicycle design, etc., body analysis data obtained by using a body measurement device, such as user's height, weight, body size, etc., and riding test data obtained by the user performing a riding test using a riding test device.

Operation S400 of generating the bicycle design may further include recommending a bicycle design by using additional data not included in the user data through application of a design recommendation engine.

Operation S420 of determining the plurality of bicycle designs by applying the second machine learning model to the determined bicycle design element may further include an operation of determining one or more bicycle designs among a plurality of preset standard bicycle designs by applying a 2nd-1 machine learning model to the determined bicycle design element.

The first machine learning model may include a plurality of GAN configured to identify the one or more bicycle design elements.

The second machine learning model may include a CNN configured to determine the bicycle design based on the one or more bicycle design elements.

Operation S300 of generating the processed command data by performing NLP on the user text data through the one or more processors may include performing vectorization on text data including the user text data in which each of the plurality of vectors may include one or more embedding.

An operation of performing NER on the plurality of vectors to identify the one or more bicycle design elements or a combination thereof may be further included.

The device and/or system described above may be implemented by a hardware component, a software component, and/or a combination of the hardware component and the software component. The device and components described in the embodiments may be implemented using one or more general-purpose or special-purpose computers such as, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device may execute an operating system (OS) and one or more software applications running on the OS. The processing device may access, store, manipulate, process, and generate data in response to execution of software. For convenience of understanding, it is described that one processing device is used, but those of ordinary skill in the art would recognize that the processing device includes a plurality of processing elements and/or a plurality of types of processing elements. For example, the processing device may include a plurality of processors or one processor and one controller. Alternatively, other processing configurations such as parallel processors may be possible.

Software may include a computer program, a code, an instruction, or a combination of one or more thereof, and may configure a processing device to operate as desired or independently or collectively instruct the processing device. The software and/or data may be permanently or temporarily embodied in any type of machine, component, physical device, virtual equipment, computer storage medium or device, or signal wave to be transmitted, so as to be interpreted by or to provide instructions or data to the processing device. The software may be distributed over computer systems connected through a network and may be stored or executed in a distributed manner. The software and data may be stored in one or more computer-readable recording media.

The method according to the embodiments may be implemented in the form of program commands that can be executed through various computer components and recorded in a computer-readable recording medium. The computer-readable recording medium may include a program command, a data file, a data structure, etc., alone or in a combined manner. The program command recorded in the medium may be a program command specially designed and configured for the embodiments or a program command known to be used by those skilled in the art of the computer software field. Examples of the computer-readable recording medium may include magnetic media such as hard disk, floppy disk, and magnetic tape, optical media such as compact disk read only memory (CD-ROM) and digital versatile disk (DVD), magneto-optical media such as floptical disk, and a hardware device especially configured to store and execute a program command, such as read only memory (ROM), random access memory (RAM), flash memory, etc. Examples of the program command may include not only a machine language code created by a complier, but also a high-level language code executable by a computer using an interpreter. The foregoing hardware device may be configured to be operated as at least one software module to perform an operation of the embodiments, or vice versa.

Although the disclosure has been described with reference to an example shown in the drawings, it will be understood by those of ordinary skill in the art that various modifications and equivalent other examples may be made from the shown example. Accordingly, the true technical scope of the disclosure should be defined by the technical spirit of the appended claims.

According to an embodiment as described above, a bicycle design method and system and a computer program stored on a recording medium to execute the bicycle design method may be implemented in which a bicycle design optimized for a bicycle user may be selected and provided by using machine learning technology. However, the scope of the disclosure is not limited by these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A bicycle design method comprising:
obtaining user data input from a user device through one or more processors;
extracting user text data from the user data through the one or more processors;
generating processed command data by performing natural language processing (NLP) on the user text data through the one or more processors; and
generating a bicycle design by using the command data,
wherein the generating of the bicycle design comprises:
determining a bicycle design element by applying a first machine learning model to the command data; and
determining one or more bicycle designs by applying a second machine learning model to the determined bicycle design element.

2. The bicycle design method of claim 1, wherein the user data comprises:
user input data obtained by a user directly inputting data comprising a gender, an age, a desired bicycle type, a desired bicycle design, and so forth;
body analysis data comprising data such as a height, a weight, a body size, and so forth of the user, obtained by using a body measurement device; and
riding test data obtained by the user performing a riding test using a riding test device.

3. The bicycle design method of claim 2, wherein the generating of the bicycle design comprises recommending a bicycle design by using additional data not included in the user data through application of a design recommendation engine.

4. The bicycle design method of claim 1, wherein the determining of the plurality of bicycle designs by applying the second machine learning model to the determined bicycle design element comprises determining one or more designs from among a plurality of preset standard bicycle designs by applying a 2nd-1 machine learning model to the determined bicycle design element.

5. The bicycle design method of claim 1, wherein the first machine learning model comprises a plurality of generative adversarial networks (GAN) configured to identify the one or more bicycle design elements.

6. The bicycle design method of claim 1, wherein the second machine learning model comprises a convolution neural network (CNN) configured to determine the bicycle design based on the one or more bicycle design elements.

7. The bicycle design method of claim 1, wherein the generating of the processed command data by performing NLP on the user text data through the one or more processors comprises performing vectorization on text data comprising the user text data, wherein each of the plurality of vectors comprises one or more embedding.

8. The bicycle design method of claim 7, further comprising performing named entity recognition (NER) on the plurality of vectors to identify the one or more bicycle design elements or a combination thereof.

9. The bicycle design method of claim 1, further comprising determining a final bicycle design by applying a third machine learning model to the one or more bicycle designs.

10. A bicycle design system comprising a memory storing one or more computer-readable instructions and a processor configured to execute the one or more instructions stored in the memory,
wherein the processor is further configured to:
obtain user data input from a user device;
extract user text data from the user data;
generate processed command data by performing natural language processing (NLP) on the user text data; and
generate a bicycle design by using the command data,
wherein, in the bicycle design, a bicycle design element is determined by applying a first machine learning model to the command data,
one or more bicycle designs are determined by applying a second machine learning model to the determined bicycle design element, and
a final bicycle design is determined by applying a third machine learning model to the one or more bicycle designs.

11. A computer program stored on a recording medium for executing, using a computer, the bicycle design method according to claim 1.
